(19) United States
(12) Patent Application Publication
(10) Pub. No.: US 2002/0065666 A1
(43) Pub. Date: May 30, 2002

(54) Method and system for transferring money orders

(76) Inventor: Jose Ignacio Zorrila De San Martin Soto, Mexico (MX)

Correspondence Address: BIRCH STEWART KOLASCH & BIRCH, PO BOX 747, FALLS CHURCH, VA, 22040-0747, US

(21) Appl. No.: 09/725,494

(22) Filed: Nov. 30, 2000

(51) Int. Cl. G06F 17/60

(52) U.S. Cl. 705/1

(57) ABSTRACT

A method and system for transferring money orders from a remitter to a payee comprises providing the remitter with a pre-paid money order receipt, receiving associated money order transaction data from said remitter, maintaining a database of valid money order receipts and related data and determining if the transaction data submitted by said remitter is valid, if valid, activating the transaction, receiving money order transaction data from a payee and determining if that transaction data is activated in the data base and, if the transaction data is determined to activated, delivering said payee the amount pre-paid by the remitter. The method may be performed through a communication network.

### FIELD OF THE INVENTION

The present invention relates to a method and system for remitting a money order in which a user may acquire a prepaid money order receipt of a predetermined amount at an authorized dealer or point of sale, and send the amount to a receiver or payee, assuring that the amount is immediately transferred and is properly and securely delivered to said payee. This may be accomplished through a communication network having a plurality of terminals.

### BACKGROUND OF THE INVENTION

A number of money order methods and systems exist for transferring money form a remitter to a payee, either internationally, i.e. from one country to another; or locally, i.e. within a city, state or country. Some of these methods and systems offer to transfer the money from the remitter to the payee in minutes. However, a number of inconveniences exist for the users of these systems.

In the conventional money order methods systems, such as those provided in the United States or in other countries by companies as Western Union, Money Gram, Ria Envia, Orlandi Valuta, Raza Express and Bancomer, a remitter is requested to follow the following steps:

a) Physically attend a facilities of the service provider to initiate the transaction;

b) Fill out a money order form, wherein the remitter registers his/her identification data as well as the payee data, i.e. name, address and telephone number, etc.;

c) Deliver to the service provider the amount of money to be transferred to the payee together with a completed form and payment of a service fee;

d) The remitter is provided with a transfer code number;

e) The remitter advises the payee, such as by a phone call, of the transfer code number.

Additionally, the payee must follow the following steps:

a) Receive the transfer information, particularly the transfer code number from the remitter:

b) Physically attend a facility of the service provider to redeem the money order;

c) Fill out a form in order to receive the money, including the transfer code number;

d) Receive the money.

In an alternative system the money may be deposited in a regular bank account.

This procedure, however, involves a number of inconveniences and undesirable requirements for both for the remitter and the payee. Often a user of these services does not wish to fill out forms with his/her personal information. This may be due to a simple objection to the inconvenience of filling out forms, or as a result of a desire to remain anonymous. Additionally, the many steps that must be taken and requirements that must be satisfied often result in a delay of delivery of the money to the payee.

A market survey of providers of money order services indicates that the key factors in choosing the money order service provider are:

the reliability that the money will be delivered to the payee;

the commission charged by the service provider;

the exchange rate applied to the money order when the transfer is made form one country to another;

how quickly the money can be obtained by the payee;

availability of a money back guarantee in case of problems with the transfer;

the possibility of designating beneficiaries; and

overall quality of service.

The main complaints of users of money order services are the high commissions charged for the money order, hidden charges, and unfavorable exchange rates applied to international money orders. Additionally, in places outside of the United States it is not unusual that money order redemption centers are located within retail establishments where the payee is often induced, if not forced, to acquire merchandise instead of receiving the money transferred. At times in such establishments the delivery of the funds transferred to the payee is delayed by hours or even days arguing that there is not enough cash available. Such practices interfere severely with normal and prompt transfer of funds.

### SUMMARY OF THE INVENTION

It is an object of the invention to overcome the difficulties associated with the money order transfer methods discussed above.

It is an object of the present invention to provide a system and method for the transfer of money orders that assures an instant transfer of the money from a remitter to a payee.

It is another object of the invention to provide a system and method for the transfer of money orders which does not require any significant infrastructure at the point of sale or the point of redemption.

It is a further object of the invention to provide a system and method for transferring money orders that is reliable, and to provide such a system and method that permits or assures anonymity of the remitter and/or payee.

In a preferred embodiment of the invention, a method of transferring money orders from a remitter to a payee comprises providing the remitter with a pre-paid money order receipt, receiving money order receipt transaction data from said remitter, maintaining a database of valid money order receipts and related data, determining if the transaction data submitted by said remitter is valid in said database, if the transaction data is determined to be valid, activating the money order transaction in the database, receiving money order transaction data from the payee, determining if the transaction data submitted by the payee is valid and activated in the data base and, if the transaction data submitted by the payee is determined to valid and activated, delivering to the payee the amount pre-paid to be transferred by the remitter.

An additional feature of the invention may include a database which also contains exchange rate information which is used in international money order transfers for immediately informing the remitter of the exchange rate and the amount to be transferred in the currency of the payee.

The invention also includes a system for implementing the method.

### BRIEF DESCRIPTION OF THE DRAWINGS

FIG. 1 is a block diagram illustrating the system and method of the present invention.

### DETAILED DESCRIPTION OF A PREFERRED EMBODIMENT OF THE INVENTION

In order to accomplish the foregoing objects, the method according to the invention comprises making accessible to a user of the method, i.e. a remitter, prepaid money order receipts of different denominations, for example $50.00, $100.00 and $200.00. The receipts may conveniently be in the form of cards. The money order receipts/cards may be easily distributed through any type of locations that are easily accessible to potential users, such as retail stores. The method if the present invention can be implemented readily using automatic dispensing machines as points of origin for transactions.

The price of the money order card may represent the total amount to be transferred and, optionally, may include a commission or fee charged to the remitter for conducting the money order transfer. For example, the total purchase price for a card transferring $50.00 could be $57.00 including a $7.00 fee for the service.

In addition to the value of the transfer, the money order card in accordance with the invention also has associated therewith transaction data. Desirably, the transaction data comprises at least two control numbers. This data should be associated with the card in a manner such that it is normally not readily perceivable. Such data maybe, for example, printed on the card but hidden by a scratch-off film. Another possibility is that such data could be magnetically recorded on a portion of the card so that it is discernable only with the aid of a reader that may be available to the user of the transfer services. As will be discussed below, such data are indispensable for transferring the money from the remitter to the payee. In a preferred embodiment of the invention the control numbers are three, i.e. a money order number, a transfer number and a secret number.

Additionally in accordance with the invention, the money order card may also contain information which will be used by the remitter to activate the money order transfer. This information may comprise a toll free telephone number, identification of an Internet web page, or some other means or medium of communication which will enable the user to communicate with the system of the invention to effect the transfer of funds.

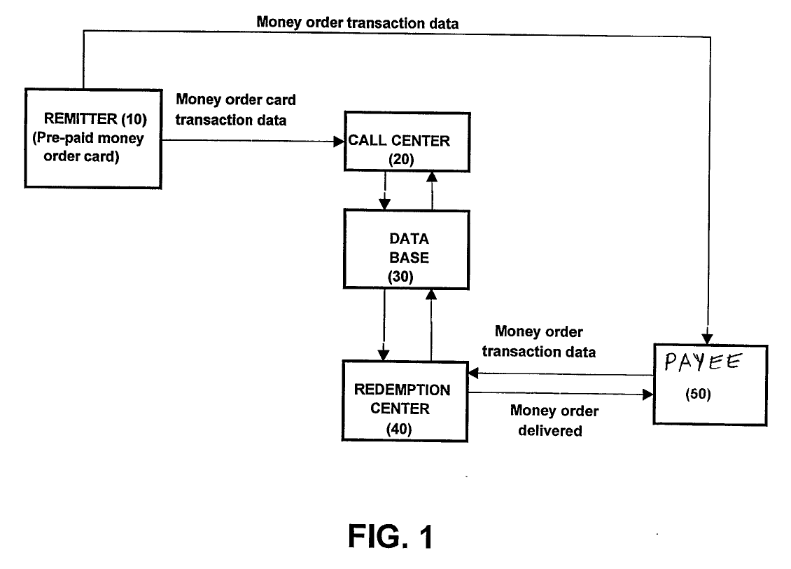

As shown at reference numeral 10 in FIG. 1, a remitter obtains a prepaid money order card by purchasing the same at a point of origin for the transaction. This may be a place where the transaction is conducted manually by a teller or salesperson. A benefit of the present invention is that the point of origin can easily be an automated terminal. Payment can be in the form of cash, check, credit card or other financial transaction depending on the nature of the point of origin, a possible desire for anonymity, or other factors that may be relevant to a particular transaction.

Once the remitter has acquired a money order card, the remitter must gain access to the transaction data associated with that card. If the data is concealed by a film, the remitter scratches off the film to reveal the control numbers associated with the purchased money order card.

The remitter then communicates with a central repository, identified for the present discussion as a “call center” 20 in FIG. 1. In one preferred embodiment of the invention, communication with the call center is via telephone using a toll free number. The remitter will provide data to the call center. This can be done by providing the data to an operator. More advantageously, the data is provided by the remitter using an IVR (interactive voice response) device, a telephone touch-tone data input system, or some other automated means for data transfer. Transfer of data over the Internet is also contemplated as another embodiment of the present invention. The remitter provides to the call center at least the control numbers associated with the money order card that has been purchased by the user.

The call center 20 comprises, or is linked with, a stored database 30. Data base 30 has been pre-loaded with information corresponding to the transaction data associated with valid money order cards that have been made available to users. The transaction data provided by the remitter 10 is compared to the data contained in the database 30. If the transaction data provided by the remitter matches data pre-stored in the data base as relating to a money order card that has been made available for purchase, the data is determined to be valid and the money order transaction is activated in the database 30. The remitter is then informed that the money order has been activated and that the money can be redeemed by the payee at any time. If the data provided by the remitter is not determined to be valid, then no transfer of funds can occur.

In addition to the transaction data, other information may be requested from the remitter. For example the name, telephone number and address of the remitter and/or the name, telephone number and address of the payee may also be loaded in the data base for the purposes of transaction control. Such data could be useful in the event that the money is not redeemed by the payee and/or the remitter requests a refund. However, this information is not essential for performing the method of the invention. If anonymity in the transaction is desired, then such information would not be appropriate.

Once the remitter has activated the money order in the database 30, the remitter communicates to the payee, identified at reference numeral 50 in FIG. 1, the money order transaction data by any means of communication, for example, by telephone, e-mail, telegraph, etc. With this information the payee will be able to redeem the money order transfer.

Payee 50 may actually visit a redemption center where he/ she provides the money order transaction data either to a cashier or to an automatic teller machine. The transaction data provided by the payee is input to the data base 30. In a preferred embodiment, the payee may communicate with database 30 via telephone, the Internet, or other automated data transfer means.

The transaction data submitted by the payee 50 is compared to the previously activated transaction data in the database. The payee's transaction data must match the transaction data previously activated by the remitter in order to verify that the payee is to receive the funds paid by the remitter. If the transaction data provided by the payee is determined to correspond to transaction data previously activated by the remitter, then the amount prepaid by the remitter is delivered to the payee.

If the payee is present at a redemption point, then the funds can be paid to the payee in any suitable manner or form. In accordance with the invention, the payee may be completing the transaction from a remote location. In that event, the system of the invention should include means for identifying a manner in which the funds will be transferred to the payee. This may include electronic transfer or credit to an account identified by the payee, forwarding of a check or other negotiable instrument to the payee, etc.

For international money order transfers, the database is also provided with information concerning the applicable exchange rate between the currencies of the countries involved in the transfer. Consequently, when an international money order is placed by a remitter, the remitter may be immediately informed of the applicable exchange rate and the exact amount that will be redeemed by the payee in the currency of the country of the payee. If desired, in view of possible fluctuations in exchange rates, the rate provided to the remitter may be guaranteed for a limited period.

The database may also contain other potentially useful information such as information concerning frequent use of the service by preferred customers, the number and value of activated money order cards outstanding, if any money order card has been stolen, the number of cashed money orders, beneficiary data in case of death of the payee, etc. Such information can be useful for various management and transaction control purposes.

1. A method for transferring money orders from a remitter to a payee, comprising:
a) providing a remitter with a pre-paid money order receipt;
b) associating transaction data with said receipt;
c) receiving money order receipt transaction data from said remitter;
d) maintaining a database of money order transaction data associated with money order transaction receipts;
e) determining if the transaction data submitted by said remitter is valid;
f) if the transaction data submitted by the remitter is valid, activating the money order transaction in said database;
g) receiving money order transaction data from said payee;
h) determining if the transaction data submitted by said payee is activated in the database; and
i) if the transaction data is determined to activated, delivering to said payee the amount of funds pre-paid by the remitter.

2. The method of claim 1, wherein said method is performed by communicating through a communication network.

3. The method of claim 1, wherein said receipt comprises a money order card.

4. The method of claim 1 wherein the step of associating transaction data with said receipt comprises printing said data on said receipt.

5. The method of claim 1, further comprising concealing said transaction data associated with said receipt, wherein said remitter reveals said transaction data after being provided with said prepaid money order receipt.

6. The method of claim 1, wherein the step of determining if the transaction data submitted by said remitter is valid comprises comparing the data submitted by the remitter with data previously stored in the database.

7. The method of claim 1, wherein the step of determining if the transaction data submitted by said payee is activated in the database comprises comparing the data submitted by the payee with data previously activated in said database.

8. The method of claim 6, wherein the step of determining if the transaction data submitted by said payee is activated in the database comprises comparing the data submitted by the payee with data previously activated in said database.

9. The method of transferring money orders of claim 1, comprising associating with said pre-paid money order receipt transaction data comprising at least two control numbers.

10. The method of claim 6, wherein said transaction data comprises data imprinted on the receipt and hidden by a scratch-off film.

11. The method of claim 1, wherein the transaction data is received via telephone call.

12. The method of claim 1, wherein the transaction data is received via internet.

13. The method of claim 1, wherein the remitter provides additional information to said database.

14. The method of claim 1, wherein the payee provides additional information to said database.

15. The method of claim 1, further comprising the step of informing said remitter, in an international money order transaction, of the applicable exchange rate and the exact amount that will be delivered to the payee.

16. A network for remitting a money order comprising:
at least one first station for issuing a prepaid money order receipt associated with money order transaction data;
at least one second station including a database comprising transaction data associated with a plurality of money order receipts;
at least one first data input location for inputting transaction data associated with a prepaid money order receipt;
a first communication link between said first data input location and said second station for communicating transaction data to said second station;
said second station including means for comparing transaction data received from said first data input location with data previously stored in said database and for activating a money order transaction when said data received from said first data input location is valid;
at least one second data input location for inputting money order transaction data;
a second communication link between said second data input location and said second station for communicating transaction data to said second station;
said second station further comprising means for comparing data received from said second data input location with data previously activated in said database; and
means for paying funds to a payee of a money order when said data received from said second data input station is valid.

17. A network as in claim 16, wherein said first station comprises an automated apparatus for dispensing prepaid money order receipts.

18. A network as in claim 16, wherein at least one of said first and second data input locations comprises a telephone.

19. A network as in claim 16, wherein at least one of said first and second data input locations comprises an internet terminal.

20. A network as in claim 16, wherein said means for paying to a payee comprises an automated teller machine.
